(19) United States
(12) Patent Application Publication
(10) Pub. No.: US 2012/0321526 A1
(43) Pub. Date: Dec. 20, 2012

(54) Apparatus for the Sublimation or Pyrolysis of Hydrocarbons Using RF Energy

(75) Inventors: Victor Hernandez, Merritt Island, FL (US); Lisa Patton, Melbourne, FL (US)

(73) Assignee: HARRIS CORPORATION, Melbourne, FL (US)

(21) Appl. No.: 13/161,116

(22) Filed: Jun. 15, 2011

(51) Int. Cl. B01J 19/12

(52) U.S. Cl. 422/186.01

(57) ABSTRACT

High power RF energy supplied to a reaction chamber at a resonant frequency is used to break the covalent bonds of a hydrocarbon material without heat. An RF signal generator may be used to supply RF energy to a resonant ring through a four port coupler. The phase of the RF energy passing through the resonant ring may be adjusted to achieve an integral multiple of a resonant wavelength. Wavelength and intensity may be adjusted to sublimate or pyrolyze the hydrocarbon material to yield a useful gaseous product.

### CROSS REFERENCE TO RELATED APPLICATIONS

This application is related to the application having attorney docket number GCSD-2323, and the application having attorney docket number GCSD-2288.

### BACKGROUND OF THE INVENTION

The present invention relates to the sublimation and pyrolysis of hydrocarbons. In particular, the present invention relates to the sublimation and pyrolysis of hydrocarbons using radio frequency (RF) energy amplified by a ring resonator.

As the world's standard crude oil reserves are depleted, and the continued demand for oil causes oil prices to rise, attempts have been made to process all manner of hydrocarbons in increasingly varied ways. For example, attempts have been made to heat subsurface heavy oil bearing formations using steam, microwave energy and RF energy. However, these attempts have been generally inefficient and costly.

Sublimation or pyrolysis of substances such as coal and shale oil may yield valuable products, such as natural gas. Sublimation is essentially taking a material from its solid phase to its gaseous phase without the presence of an intermediate liquid phase. Pyrolysis, on the other hand, involves the chemical decomposition of organic substances by heating to break down hydrogen bonds. Such a process may produce natural gas from the sublimated or pyrolyzed substances with low greenhouse gas emissions. However, existing technologies require more energy to sublimate or pyrolyze substances such as coal or shale oil than the energy that is produced.

Pyrolysis differs from other processes (combustion and hydrolysis) in which the reactions do not involve oxygen or water. Pyrolysis of organic substances typically produces gas and liquid products and leave behind a carbon rich solid residue. In many industrial applications, the process is done under pressure and at operating temperatures above 430° C. Since pyrolysis is endothermic, problems with current technologies exist in which biomass substances are not receiving enough heat to efficiently pyrolyze and result in poor quality. For such cases, it becomes imperative for an initiation reaction to be used to enhance the amount of heat applied to the hydrocarbon material.

As the organic chemical structures of various hydrocarbons ages, the aromaticity (defined as the ratio of aromatic carbon to total carbon) increases. These aromatic structures are chains of carbons that are targeted for breaking during heating processes. In order for the production of natural gas to occur, these large complex structures break during reactions and thus, increase the solubility of the organic portion of the substance. Some of these reactions are (but not limited to) cracking, alkylation, hydrogenation, and depolymerization.

Based upon research by a Cornell paper (Veshcherevich), a resonant ring can amplify RF power through the coupling of waves at its input. In order to achieve power amplification, the ring should be in a state of resonance at the test frequency. For this to be successful, the length of the ring has to be equal to an integral number of guide wavelengths of the coupled wave. Waves coupled through the ring and directional coupler creates a power gain in the ring. RF tested components must be part of the resonant ring. In order to build a resonant ring, two couplers of similar design are needed with a coupling device between them. The coupling device between the two couplers, in this paper a spherical copper cavity, should use a cavity with a strong coupling. The remaining part of the resonant ring is constructed of a rectangular wave guide. The cavity provides a wide bandwidth in which there exists a strong dependence of cavity frequency on the gap. The ERL couplers used have a wide tuning range for positioning the antenna making it easier to adjust the antenna.

### SUMMARY OF THE INVENTION

The present apparatus for the sublimation or pyrolysis of coal, shale oil and other hydrocarbons using RF energy generally comprises a resonant ring, the resonant ring including a phase adjuster and a reaction chamber, the reaction chamber having a resonant cavity. The apparatus further comprises a coupler having a first port, a second port, a third port and a fourth port. A radio frequency signal generator is connected to the coupler at the first port and configured to supply power to the resonant ring, and a dummy load connected to the coupler at the fourth port. In operation, an electrical current generated by the RF signal generator enters the resonant ring at the third port, travels through the reaction chamber and the phase adjuster, and leaves the resonant ring at the second port.

Other aspects of the invention will be apparent from this disclosure.

### BRIEF DESCRIPTION OF THE DRAWINGS

FIG. 1 illustrates an embodiment of the present process for sublimation/pyrolysis using RF energy.

FIG. 2 illustrates a reaction chamber associated with the present process for sublimation/pyrolysis using RF energy of FIG. 1.

FIG. 3 illustrates the ring power gain as a function of ring attenuation for the embodiment illustrated in FIG. 1.

FIG. 4 illustrates the ring power gain as a function of coupling factor for the embodiment illustrated in FIG. 1.

FIG. 5 illustrates the ring attenuation as a function of coupling factor for the embodiment illustrated in FIG. 1.

### DETAILED DESCRIPTION OF THE PREFERRED EMBODIMENTS

The subject matter of this disclosure will now be described more fully, and one or more embodiments of the invention are shown. This invention may, however, be embodied in many different forms and should not be construed as limited to the embodiments set forth herein. Rather, these embodiments are examples of the invention, which has the full scope indicated by the language of the claims.

FIG. 1 illustrates an embodiment of the present apparatus 10 for sublimation/pyrolysis of coal, shale oil and other hydrocarbons using RF energy. An RF signal generator 12 supplies power to a resonant ring 32 through a four-port coupler 14. For the purpose of this invention, a transmitter of a non-specific power range is used to supply power to the resonant ring. RF signal generator 12 is connected to four-port coupler 14 at first port 16. Electrical current 26 generated by RF signal generator 12 enters resonant ring 32 at third port 20 and travels through reaction chamber 34 and phase adjuster 36, and returns to four port coupler 14 at second port 18. All or a portion of this current joins incoming current 26 from RF signal generator 12 to form current 30, which then repeats the circuit around resonant ring 32. A power meter 38 may be connected to resonant ring 32 between third port 20 and reaction chamber 34.

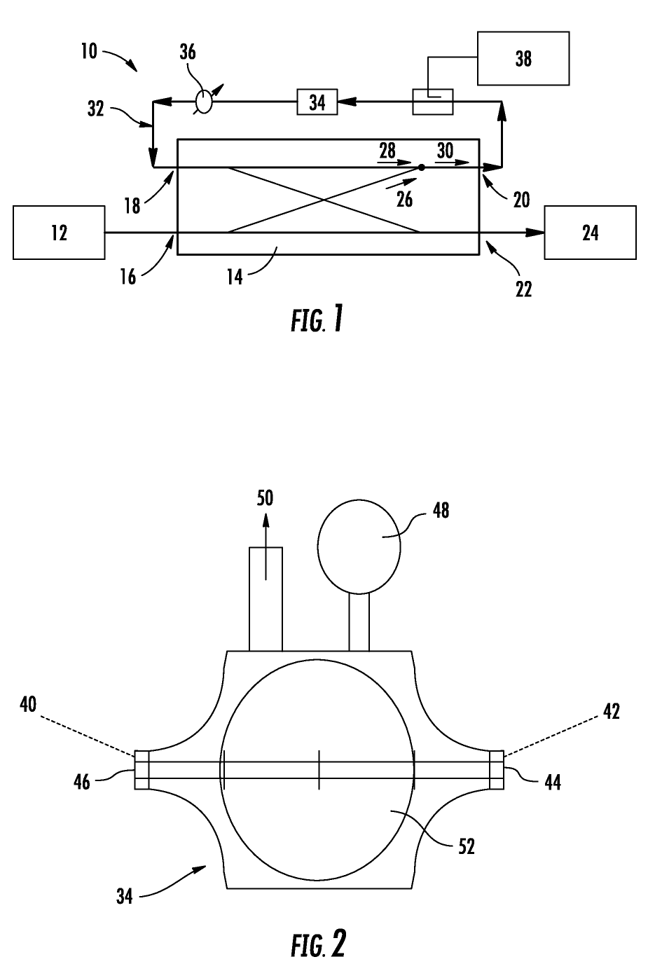

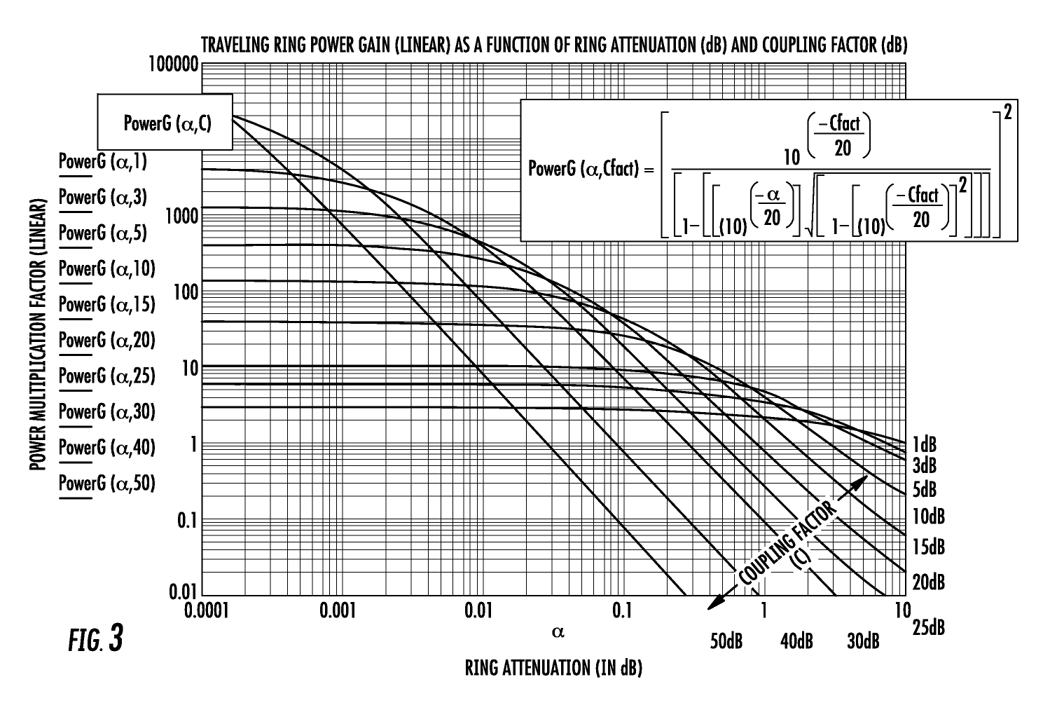

The resonant cavity provides a flexible pyrolysis/sublimation reaction chamber for evaluating optimal RF frequency versus RF power versus secondary bias source (wavelength and intensity) for a given heat range. RF discharge plasma generated in the resonant cavity 52 of the reaction chamber 34 (see FIG. 2) creates a measurable gas production. The resonant ring 32 will support continuous fuel production and can be tuned as discussed below.

The structure of resonant ring 32 and phase adjuster 36 serve to “tune” resonant ring 32 to a resonant frequency of reaction chamber 34 to optimize sublimation/pyrolysis in reaction chamber 34. Phase adjuster 36 can adjust the phase of current 30 traveling resonant ring 32 to achieve an integral multiple of the resonant wavelength. The RF energy in reaction chamber 34 is used to break the covalent bonds of hydrocarbon molecules placed in reaction chamber 34 without heat. As a result, temperatures in reaction chamber may be optimal for sublimation and/or pyrolysis. High power is achieved by synchronizing RF signal generator 12 with resonant ring 14 architecture. Tuning may be useful to favor hydrogen production and the removal of sulfur in the present sublimation/pyrolysis process or maximize natural gas production. This tuning provides optimal lower temperatures for sublimation and minimal energy consumption.

A dummy load 24 is a passive device connected to four-port coupler 14 at fourth port 22. Dummy load 24 is used to absorb and dissipate energy not needed for the sublimation/pyrolysis process. Thus, not all current entering four port coupler 14 at second port 18 joins the current 26 from signal generator 12 as some may be diverted to dummy load 24. Preferably, a four port coupler is sized appropriately to dissipate low amounts of energy for efficiency.

FIG. 2 provides a closer look at reaction chamber 34, which is shown separate from resonant ring 32. RF energy enters reaction chamber 34 at first connection 44 and exits at second connection 46. Reaction chamber 34 is coupled to resonant ring 32 architecture through dielectric pressure ports 40 and 42. Dielectric pressure ports 40 and 42 are windows that are transparent to RF energy, but isolate resonant cavity 52 of reaction chamber 34 from the resonant ring with regard to the material for sublimation/pyrolysis placed in reaction chamber 34. The construction of the reaction chamber is not materials specific and may consist of one or combination of suitable materials.

RF energy is used to break the covalent bonds of hydrocarbons introduced into resonant cavity 52 of reaction chamber 34 and release gaseous products, which then exit reaction chamber 34 at gas port 50. A gas chromatograph (not shown) may be connected in the gas stream at or near gas port 50 to monitor the content of the gas stream leaving reaction chamber 34 to facilitate tuning of the process. Pressure and temperature measurement devices 48 are in functional contact with resonant cavity 52.

Equating component waves around resonant ring 32 may be predicted according to the following formulas:

$${E}_{4} = {E}_{4} {e}^{- i φ} ( {10}^{\frac{- \partial }{20}} ) \sqrt{1 - {c}^{2}} + {cE}_{1}$$

$${cE}_{1} = {E}_{4} ( 1 - {e}^{- i φ} ( {10}^{\frac{- \partial }{20}} ) \sqrt{1 - {c}^{2}} )$$

$$\frac{{E}_{4}}{{E}_{1}} = \frac{c}{1 - {e}^{- i φ} ( {10}^{\frac{- \partial }{20}} ) \sqrt{1 - {c}^{2}}}$$

$$\frac{{P}_{4}}{{P}_{1}} = {\{ \frac{c}{1 - {e}^{- i φ} ( {10}^{\frac{- \partial }{20}} ) \sqrt{1 - {c}^{2}}} \}}^{2}$$

$${G}_{linear} = {\{ \frac{c}{1 - ( {10}^{\frac{- \partial }{20}} ) \sqrt{1 - {c}^{2}}} \}}^{2}$$

$${G}_{linear} = {\{ \frac{{10}^{\frac{- C}{20}}}{1 - ( {10}^{\frac{- \partial }{20}} ) \sqrt{1 - {( {10}^{\frac{- C}{20}} )}^{2}}} \}}^{2}$$

### Where:

Gₗᵢₙₑₐᵣ=the linear power gain;

α=the attenuation around the loop in dB;

φ=2πnλ, where n is an integer;

C=coupling factor in dB; and

c=10^{-C/20}

The ring performance can be measured using the power gain equation which is dependent on several variables within the system: coupling coefficient, attenuation and reflection in the ring, transmission, and electrical length.

FIGS. 3-5 illustrate performance characteristics of resonant ring 32 in three different ways. Turning to FIG. 3, the power gain (G) of resonant ring 32 is shown as a function of ring attenuation (α). Coupling factor (C) is represented across the graph, as four port coupler 14 is variable in character. The present apparatus for sublimation/pyrolysis using RF energy 10 is designed to have a very small power loss around resonant ring 32.

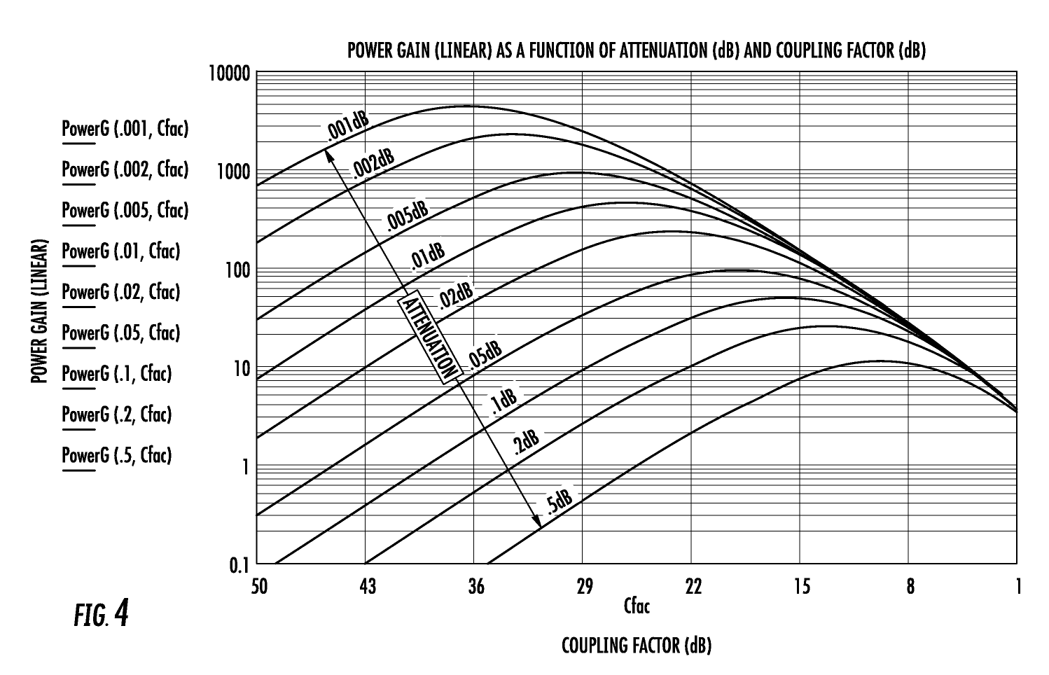

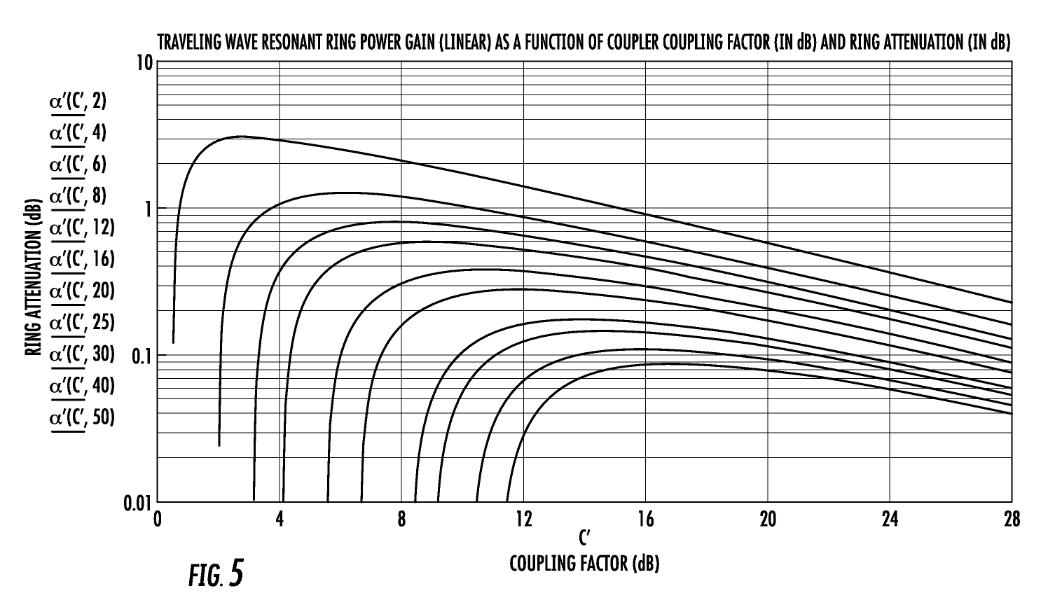

FIG. 4 looks at the performance of resonant ring 32 using the power gain (G) around resonant ring 14 as a function of coupling factor (C). Here, ring attenuation (a) is represented across the graph. There exists the optimal coupling coefficient and the power gain is maximal.

In FIG. 5, the ring attenuation (a) is shown as a function of coupling factor (C). Power gain (G) is represented across the graph at the high end of the coupling factor (C). This figure is another way to express the traveling wave guide and determine the maximum power gain possible at the specified coupling factor.

Overall, a signal generator is coupled to a resonant ring test fixture. The resonant cavity is structured in such a way to receive high power and synchronize the RF signal generator with the resonant ring structure. The pyrolysis and/or sublimation reaction chamber is coupled to the resonant ring through dielectric ports. This reaction chamber is designed to easily evaluate the optimal RF frequency, RF power, and wavelength and intensity in order to maximize the amount of outputs from the hydrocarbon substance that is under test. RF discharge substances generated during the chemical reactions of the pyrolysis/sublimation are to be measured and analyzed. The resonant ring is designed to support continuous operation.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged either in whole or in part. Therefore, the spirit and scope of the appended claims should not be limited to the description of the preferred versions contained herein.

1. An apparatus for the sublimation or pyrolysis of coal, shale oil and other hydrocarbons using radio frequency energy, the apparatus comprising:
a resonant ring, the resonant ring including a phase adjuster and a reaction chamber, the reaction chamber having a resonant cavity;
a coupler having a first port, a second port, a third port and a fourth port, the coupler third port being coupled to the resonant ring;
a power supply connected to the coupler at the first port and configured to supply radio frequency energy to the resonant ring; and
a dummy load connected to the coupler at the fourth port;
wherein an electrical current generated by the power supply enters resonant ring at the third port, travels through the reaction chamber and the phase adjuster, and leaves the resonant ring at the second port.

2. The apparatus of claim 1, wherein the power supply comprises a radio frequency signal generator.

3. The apparatus of claim 1, wherein the resonant ring further comprises a power meter.

4. The apparatus of claim 1, further comprising dielectric pressure ports couopling the reaction chamber to the resonant ring.

5. The apparatus of claim 1, wherein reaction chamber further comprises a gas port.

6. The apparatus of claim 4, wherein a gas chromatograph is configured to monitor the content of a gas stream leaving the gas port of the reaction chamber.

7. The apparatus of claim 1, wherein reaction chamber further comprises a pressure measurement device and a temperature measurement device to measure pressure and temperature within the resonant cavity.

8. The apparatus of claim 1, wherein the phase adjuster is configured to adjust the wavelength of the radio frequency energy to achieve an integral multiple of a resonant wavelength.

9. The apparatus of claim 8, wherein the reaction chamber contains hydrocarbons, and the adjustment of the wavelength of the radio frequency energy amplifies the power of the radio frequency energy to break at least some of the covalent bonds of the hydrocarbons.
